(19) United States
(12) Patent Application Publication
(10) Pub. No.: US 2009/0070136 A1
(43) Pub. Date: Mar. 12, 2009

(54) SYSTEMS AND METHODS FOR MEDICATION MANAGEMENT USING MULTIPLE SOFTWARE APPLICATIONS

(75) Inventors: Mark Morita, Arlington Heights, IL (US); William Douglas Hughes, Bainbridge Island, WA (US); Christopher Michael McQuistin, Federal Way, WA (US); Shankar Saibabu, Nashua, NH (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/853,593

(22) Filed: Sep. 11, 2007

(51) Int. Cl. G06Q 50/00

(52) U.S. Cl. 705/2

(57) ABSTRACT

Certain embodiments of the present invention provide a system for medication management including a user interface, a processor, and a display component. The user interface is adapted to receive patient data. The processor is adapted to aggregate medication data from at least one medication data source. The display component is adapted to display the medication data.

### BACKGROUND OF THE INVENTION

The present invention generally relates to medication management. More specifically, the present invention relates to systems and methods for managing a patient's medications regardless of its source.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), medication administration records (MAR), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during treatment, medical personnel may access patient information that is stored in a medical information system, such as the medications currently being taken by the patient.

Healthcare providers are under constant pressure to provide treatment to their patients as effectively and efficiently as possible. To do so, providers must review large amounts of data from a variety of disparate sources. As the prevalence of pharmaceuticals continues to grow, complete and correct medication information is especially critical to providers in preventing potentially life-threatening medication errors.

Despite the gravity of these concerns, comprehensive medication information remains difficult to obtain for several reasons. First, many patients receive different medications in the hospital and ambulatory settings, each of which may use a different medication management system. Additionally, medications that are ordered by a provider may not actually be taken by the patient. Moreover, over-the-counter medications and medications provided by an alternative medicine provider may not be included in a patient's medical records.

In addition to understanding what medications a patient is currently taking, a provider must also recognize how the different medications interact with one another. Clinical decision support systems seek to provide such assistance to healthcare providers. For example, clinical decision support systems may perform interaction checking on prescription orders for possible adverse drug interactions. Interaction checking may include, for example, drug-to-drug interactions, dose range warnings, drug allergies, duplicate drugs, and/or therapeutic duplication.

Currently available applications are unable to manage a patient's medications obtained from a variety of sources that include doctor's office samples, 90-day mail-in prescriptions, pharmacy prescriptions, over-the-counter providers, and dietary supplements. Moreover, these applications are unable to provide clinical decision support based on a comprehensive understanding of a patient's medication information across multiple disparate sources. Existing systems are not standardized in their medical formularies, and accepting external medication information into the system may create liability issues or problems associated with real-time decision support.

Thus, there is a need for a system and method for medication management using multiple software applications.

### BRIEF SUMMARY OF THE INVENTION

Certain embodiments of the present invention provide a system for medication management including a user interface, a processor, and a display component. The user interface is adapted to receive patient data. The processor is adapted to aggregate medication data from at least one medication data source. The display component is adapted to display the medication data.

Certain embodiments of the present invention provide a method for medication management. The method includes selecting a patient, aggregating medication data from at least one medication data source, and displaying the medication data. In an embodiment, the processing occurs without the intervention of a user.

Certain embodiments of the present invention provide a computer-readable medium including a set of instructions for execution on a computer. The set of instructions includes a selection routine configured to select a patient, an aggregation routine configured to aggregate medication data from at least one medication data source, and a display routine configured to display the medication data. In an embodiment, the processing occurs without the intervention of a user.

### BRIEF DESCRIPTION OF SEVERAL VIEWS OF THE DRAWINGS

FIG. 1 illustrates a system for medication management used in accordance with an embodiment of the present invention.

FIG. 2 illustrates a flow diagram for a method for medication management used in accordance with an embodiment of the present invention.

FIGS. 3-6 illustrate exemplary screen shots of an example application of a medication management system used in accordance with an embodiment of the present invention.

FIG. 7 illustrates an exemplary screen shot 700 of an example application of a medication management system that has been integrated into an existing information management system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

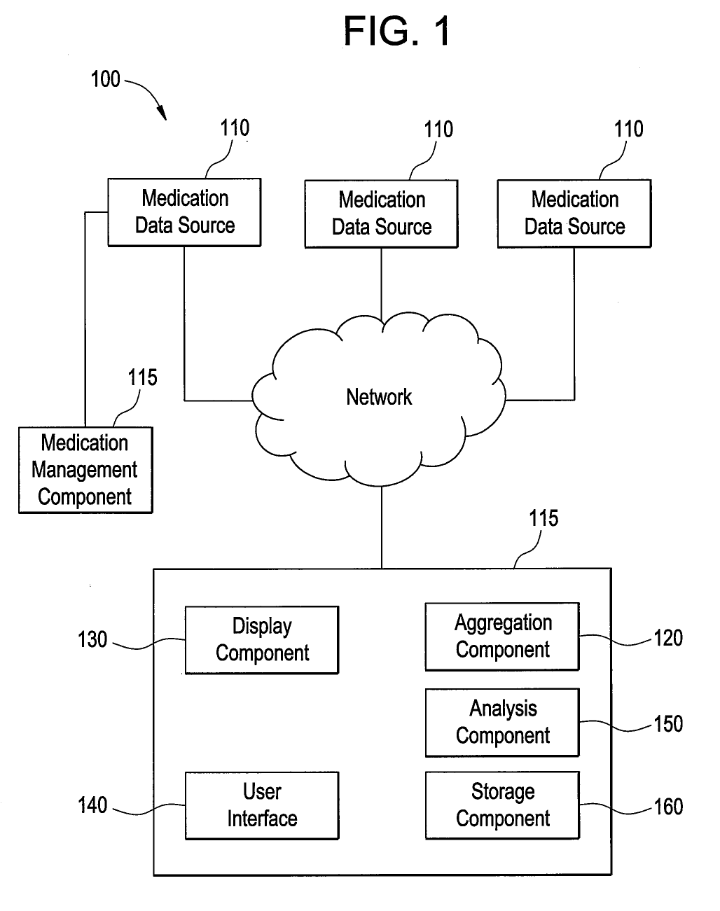

FIG. 1 illustrates a system 100 for medication management used in accordance with an embodiment of the present invention. The system 100 includes a plurality of medication data sources 110 and a medication management component 115. In certain embodiments, the medication management component 115 includes an aggregation component 120, a display component 130, a user interface 140, an analysis component 150, and a storage component 160.

In an embodiment of the present invention, each of the plurality of medication data sources 110 communicates with the aggregation component 120 over one or more networks. The network may be or may be part of an intranet, the Internet, an HIS, an RIS, or a PACS, for example. Additionally, each of the plurality of medication data sources 110 may be independent and distinct from one another. For example, one of the plurality of medication data sources 110 may be an EMR, while another may be a doctor or other health professional and still another may be the patient. Alternatively, each of the plurality of medication data sources 110 may be, for example, a CIS, a CVIS, an RIS, a PACS, an LIS, an HIS, or a pharmacy. In still another embodiment, a medication management component 115 may be associated with one or more of the plurality of medication data sources 110. In this embodiment, the medication data source 110 may be integrated within the medication management component 115 or may be configured to receive medication data from the medication management component 115.

The medication data provided by each of the plurality of medication data sources 110 is associated with a patient. By utilizing the user interface 140 of the medication management component 115, a user of the system 100 selects a patient whose medication data the user would like to view. Next, the aggregation component 120 aggregates the information provided by the plurality of medication data sources 110 for the selected patient. Once aggregation is complete, the aggregated medication data is provided to the display component 130 so that the information may be displayed to a user of the system 100.

In certain embodiments, the medication data to be aggregated may include the name of one or more medications, the patient's medical or medication history, and information regarding the patient's known allergies. Additionally, the medication data may include information such as the dosage of a medication, how frequently a medication is to be taken (dosing frequency), and the length of time over which the medication is to be taken (dosing period). The medication data to be aggregated may also include other information about a medication, such as dosing instructions and the physical form of the medication. The medication data may also include a description or visual representation of one or more physical characteristics, such as the color or shape, of a medication.

In an embodiment, the analysis component 150 further analyzes the information provided by the plurality of medication data sources 110. For example, the analysis component 150 may analyze the information to determine a potential interaction between two or more medications that are currently being taken or are prescribed to be taken by a patient. To achieve this functionality, the analysis component 150 may include a processor adapted to process data. In an embodiment, current best practices may be embedded within the analysis component 150. Alternatively, the analysis component 150 may be adapted to communicate with a local or remote reference that includes medication information. In another embodiment, the analysis component 150 is capable of projecting the outcome of a current or proposed course of medication or treatment in order to form a predictive model of the treatment results.

In still another embodiment, data that has been aggregated or is used in medication data analysis may be stored in the storage component 160. For example, medication data that has been aggregated may be stored in the storage component 160 until the user of the system 100 requests that the medication data be displayed. In other embodiments, the storage component 160 may include rules or reference materials that are used by the analysis component 150. For example, the storage component 160 may include a rule that if a single medication is prescribed simultaneously for a single patient by two different health professionals, then a warning is provided that the prescriptions may be duplicative. As another example, the storage component 160 may include the Physician's Desk Reference Drug Interactions and Side Effects Index, which may be referenced by the analysis component 150 in determining the effects of the patient's medication regimen.

In another embodiment, the analysis component 150 generates an alarm or warning to indicate that the patient may experience a potentially adverse reaction to a treatment. Alternatively, the analysis component 150 may also generate a list of one or more alternative medications or courses of treatment that tend to avoid potentially adverse consequences to the patient's health.

In yet another embodiment, the aggregation component 120 is capable of aggregating medication data to form textual or visual representations of a patient's past, present, or future medication status. As described above, the aggregation component 120 then provides the medication data, including both textual and visual representations of the medication data, to the display component 130.

In other embodiments, the medication data received and displayed by the display component 130 may include a variety of additional information. For example, the displayed medication data may include a projected outcome of a treatment or medication. Alternatively, the display component 130 may display a warning or alert when certain medications are prescribed or taken together or when a patient with specific symptoms is being prescribed or is taking a medication that may cause an adverse reaction. In an embodiment, the display component 130 displays textual or visual representations of medication data using one or more indicators, such as a particular color. For example, an alert or warning may be displayed in red to indicate to the user of the system 100 to read the alert or warning and modify the patient's treatment or medications accordingly.

In still another embodiment, the display component 130 displays hyperlinks to other resources containing information relevant to medication management. For example, the display component 130 may display to a user of the system 100 a hyperlink that is associated with a particular section of the Physician's Desk Reference or some other pertinent resource that is stored locally on the system 100. Alternatively, the display component 130 may display a hyperlink associated with a resource that is located remotely from the system 100, such as an Internet webpage. In either scenario, a user of the system 100 may access one or more of these additional resources by utilizing the user interface 140 to select the hyperlink associated with the desired resource.

In alternative embodiments, the user interface 140 may be configured in a variety of ways. For example, the user interface 140 may include a touch screen associated with a mobile communication device. Alternatively, the user interface 140 may include a keyboard, mouse, or other data input or selection device. Additionally, the user interface 140 may be configured to allow a user of the system 100 to print all or part of the medication data. In an alternative embodiment, the user interface 140 is configured to allow the user to download to a local memory or transmit to a remote server all or part of the medication data. For example, the user interface 140 may be adapted to allow a user of the system 100 to transmit the medication data in an electronic mail. In other embodiments, the medication data may be downloaded or transmitted according to other transfer protocols, such as file transfer protocol (FTP), simple mail transfer protocol (SMTP), or hypertext transfer protocol (HTTP).

In certain embodiments, multiple functions may be performed by a single component of the medication management component 115. For example, the analysis component 150 and the aggregation component 120 may be integrated so that aggregation and analysis of medication data is performed by a single component. Alternatively, multiple components of the medication management component 115 may function together to perform a single function. For example, the user interface 140 and the display component 130 may collectively perform the function of graphically presenting information to the user of the system 100.

In yet another embodiment, the overall system 100 for medication management may be integrated with another system 100. In an embodiment, one or more components of a first system 100 may be linked with one or more components of a second system 100. For example, the medication management component 115 of a first system 100 may function as the medication data source 110 of a second system 100.

The components and functionality of the system 100 may be implemented alone or in combination in hardware, firmware, or as a set of instructions in software, for example. Certain embodiments may be provided as a set of instructions residing on a computer-readable medium, such as a memory, CD, DVD, or hard disk, for execution on a general purpose computer or other processing device, such as a PACS workstation.

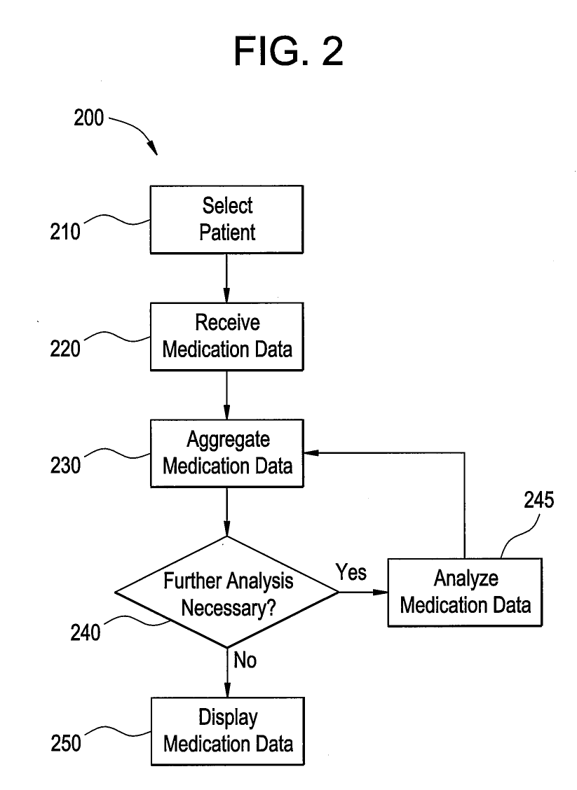

FIG. 2 illustrates a flow diagram for a method 200 for medication management used in accordance with an embodiment of the present invention. The method 200 includes the following steps, which will be described below in more detail. At step 210, the patient is selected. At step 220, the patient's medication data is received. At step 230, the patient's medication data is aggregated. At decision point 240, it is determined whether the medication data requires further analysis. At conditional step 245, if the medication data does require further analysis, the data is further analyzed. At step 250, the medication data is displayed. The method 200 is described with reference to elements of systems described above, but it should be understood that other implementations are possible.

At step 210, the patient is selected. In an embodiment, the patient is selected by utilizing a user interface, which may be similar to the user interface 140 described above, for example. In an embodiment, the selection is based at least in part on patient data. For example, a patient's name may be selected from a list of patients displayed in a drop-down menu. Alternatively, a patient may be selected according to a search query entered using a keyboard. For example, if the search term “Smith” is entered via the user interface, the patient John Smith may be selected automatically. In other embodiment, before selecting John Smith, the user interface may prompt for confirmation that John Smith is the patient that is to be selected. In still other embodiments, the patient data from which the selection is based may include, for example, the patient's social security number, address, telephone number, physician, hospital identification number, or some other identifier.

At step 220, the selected patient's medication data is received. In an embodiment, the patient's medication data is received by an aggregation component. The aggregation component may be similar to the aggregation component 120 described above, for example. In an embodiment, the patient's medication data may be received from a plurality of distinct medication data sources. For example, some portion of the medication data may originate from an electronic medical record associated with the patient, while other medication data may originate from a pharmacy record. The medication data received may include the name of one or more medications, the patient's medical history, and information regarding the patient's known allergies. The medication data may also include information relating to the dosage, dosing frequency, and dosing period of a medication. The medication data may further include dosing instructions and a description or visual representation of the physical form or appearance of a medication.

At step 230, the patient's medication data is aggregated. In an embodiment, this aggregation may be performed by an aggregation component, which may be similar to the aggregation component 120 described above, for example. The aggregation of the patient's medication data may be performed based at least in part on information about the patient. For example, if the patient has been diagnosed with high blood pressure, then the medication data may be aggregated in a way that illustrates the effects of one or more medications or treatments on the patient's blood pressure.

In an embodiment, the aggregation may be performed based at least in part on information about one or more medications. For example, if the patient is currently taking or may be prescribed a medication for regulating the patient's blood sugar, then the patient's medication data may be aggregated in a way that illustrates the effects of one or more medications or treatments on the patient's blood sugar level.

In an embodiment, medication data originating from multiple different medication data sources may be aggregated in order to provide a comprehensive overview of the various medications the patient is or will be taking.

At decision point 240, it is determined whether the medication data requires further analysis. In an embodiment, a patient's medication data may be analyzed before it is entirely aggregated. For example, before a patient is prescribed one medication for lowering the patient's blood pressure and another medication for regulating the patient's blood sugar level, the prescribing physician may wish to know whether taking both medications will cause the patient to react adversely to either treatment. When used in combination, some medications may react synergistically and therefore make the effects of one or both medications more profound. Alternatively, other medications react antagonistically when used in combination, thus reducing the effectiveness of either or both medications. Moreover, still other medication combinations can have significant and even dangerous side effects on the patient.

In certain embodiments, the decision point 240 may be configured in a variety of ways. In an embodiment, the decision point 240 may include automatically determining whether further analysis is necessary based on, for example, one or more pre-programmed rules. Alternatively, the decision point 240 may be configured so that further analysis is performed at conditional step 245 only if a user of the medication management system requests information requiring further analysis. For example, if the user requests a list of potential interactions between two or more medications or an illustration of potential outcomes for a treatment, then the analysis necessary to obtain that information is performed at conditional step 245.

At conditional step 245, if the medication data does require further analysis, the data is further analyzed. For example, if multiple medications are being taken or prescribed, then additional analysis of the medication data may be performed. In this example, a medical reference guide may be consulted to determine the probable interaction between the medications. The analysis of conditional step 145 may be performed by an analysis component, which may be similar to the analysis component 150 described above, for example. In an embodiment, if an adverse interaction will or may occur from the combination of two or more treatments, then additional analysis may be performed to determine one or more substitute medications or a modified dosing schedule. Additionally, further analysis may occur at conditional step 245 to develop a predictive model or projected outcome of a patient's treatment. In another embodiment, the additional analysis occurring at step 245 may include referencing the patient's medical history or allergy information to determine potential adverse effects of one or more medications.

As described above with regard to FIG. 1, certain embodiments of the present invention contemplate storing medication data that is aggregated or information useful in analyzing medication data. The data may be stored in a storage component similar to the storage component 160 described above, for example. In an embodiment, medication data that has been aggregated may be stored until it is displayed. In other embodiments, rules or reference materials that are used in analyzing medication data may be stored.

At step 250, the medication data is displayed. In an embodiment, the medication data is displayed by a display component. The display component may be similar to the display component 130 described above, for example. In embodiments of the method 200, the medication data displayed at step 250 may include any of the information described above with regard to step 220. Additionally, warnings, alerts, and hyperlinks to other resources may be displayed at step 250. The medication data may be displayed using textual or visual representations, or some combination thereof.

One or more of the steps of the method 200 may be implemented alone or in combination in hardware, firmware, and/or as a set of instructions in software, for example. Certain embodiments may be provided as a set of instructions residing on a computer-readable medium, such as a memory, CD, DVD, or hard disk, for execution on a general purpose computer or other processing device, such as, for example, a PACS workstation.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

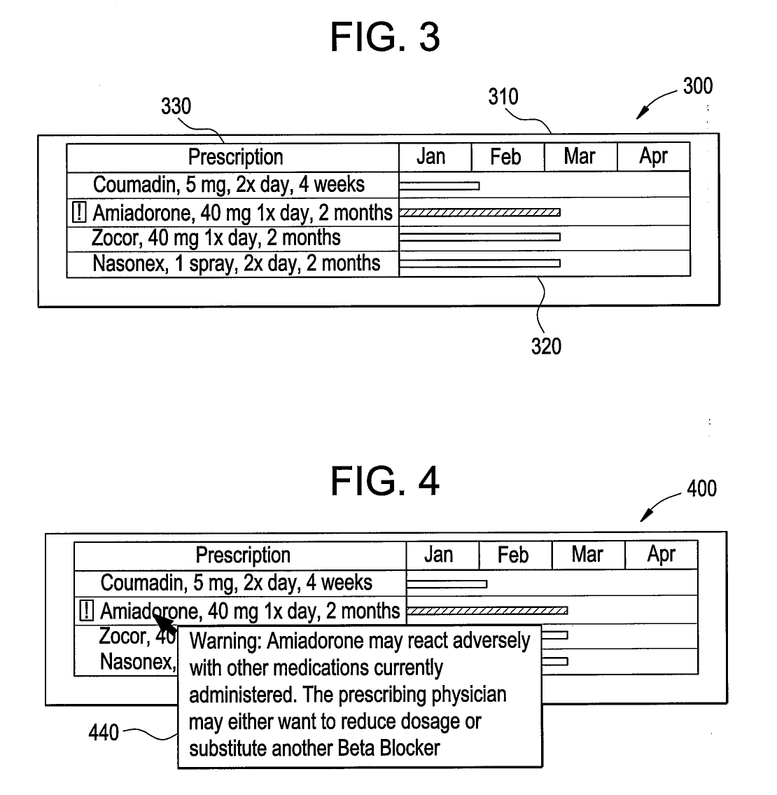

FIGS. 3 and 4 illustrate exemplary screen shots 300 and 400, respectively, of an example application of a medication management system used in accordance with an embodiment of the present invention. In an embodiment, the screen shots 300 and 400 may be associated with a display, which may be similar to the display component 130 described above, for example. In another embodiment, the screen shots 300 and 400 may be associated with a user interface, which may be similar to the user interface 140 described above, for example.

The exemplary screen shot 300 includes a timeline 310, a chart area 320, and a medication list 330. As shown in FIG. 3, medication data associated with four medications has been aggregated and displayed in the medication list 330. Each medication entry includes the name of the medication and the dosage, dosing frequency, and dosing period for each medication. At right, the chart area 320 includes a chart that visually indicates the dosing period for each medication according to the timeline 310. Additionally, the fourth medication listed in the medication list 330 (Nasonex) includes information about the physical form of the medication (a spray). Furthermore, the second medication listed in the medication list 330 (Amiadorone) is displayed in a color that is distinct from the other listed medications and includes a symbol next to the medication name. These indicators signal to the user of the medication management system that there is a warning or alert associated with the Amiadorone medication.

FIG. 4 illustrates an exemplary screen shot 400 similar to the exemplary screen shot 300 shown in FIG. 3. The exemplary screen shot 400 further includes a warning signal 410. As shown in FIG. 4, when the user points to the Amiadorone entry, the warning signal 410 displays a warning that “Amiadorone may react adversely with other medications currently administered.” The warning signal 410 also suggests to the prescribing physician that, to prevent such an adverse reaction, the dosage of Amiadorone should be reduced or another Beta Blocker medication should be substituted to replace Amiadorone.

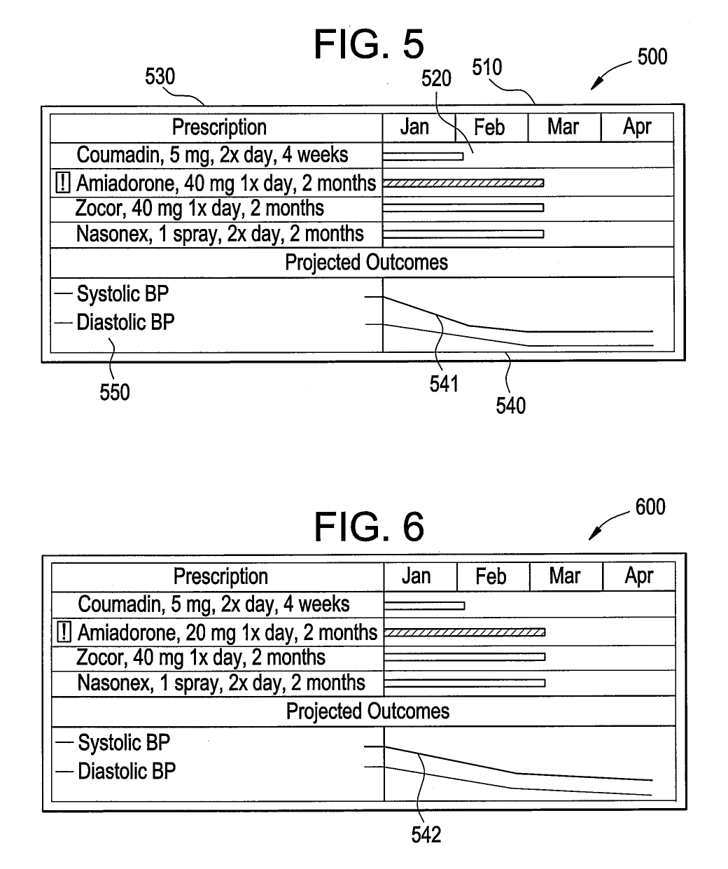

FIGS. 5 and 6 illustrate exemplary screen shots 500 and 600, respectively, of an example application of a medication management system used in accordance with an embodiment of the present invention. As described above with regard to the screen shots 300 and 400 of FIGS. 3 and 4, respectively, the screen shots 500 and 600 may be associated with a display or a user interface, for example.

The exemplary screen shot 500 includes a timeline 510, a chart area 520, a medication list 530, an outcomes display area 540, a legend 550, and a slope 541. As shown in FIG. 5, medication data associated with four medications has been aggregated and displayed in the medication list 530, as in FIGS. 3 and 4. Each medication entry includes the name of the medication and the dosage, dosing frequency, and dosing period for each medication. At right, the chart area 520 includes a chart that visually indicates the dosing period for each medication according to the timeline 510. The outcomes display area 540 includes two graphs representing the projected outcomes of administering the medications listed in the medication list 530. As indicated in the legend 550, one graph represents the patient's systolic blood pressure, while the other graph represents the patient's diastolic blood pressure. As indicated by the months listed in the timeline 510, the graphs represent the patient's blood pressure levels over time. In the example depicted in FIG. 5, it is apparent that the medication regimen is expected to lower the patient's systolic and diastolic blood pressures gradually during January and February. At some point between February and March, which is approximately when all medication dosing periods will have ended, the patient's systolic and diastolic blood pressures are expected to level off.

A close comparison of FIGS. 5 and 6 indicates that the dosage of Amiadorone has a significant effect on the rate at which the patient's systolic blood pressure is expected to decrease over time. FIG. 5 illustrates an example medication regimen in which 20 mg of Amiadorone is administered daily over a period of 2 months. In contrast, FIG. 6 illustrates an example regimen in which 40 mg of Amiadorone is administered daily over the same period. As shown in the graphs displayed in the outcomes display area 540, the patient's systolic blood pressure is expected to decrease more quickly under the FIG. 5 regimen than under the FIG. 6 regimen. As shown in FIGS. 5 and 6, the slope 541 of the FIG. 5 graph is steeper than the slope 542 of the FIG. 6 graph. Using this information, a prescribing physician is able to develop a proper course of treatment more easily and efficiently than would be possible without this aggregated, processed, and visually represented medication data.

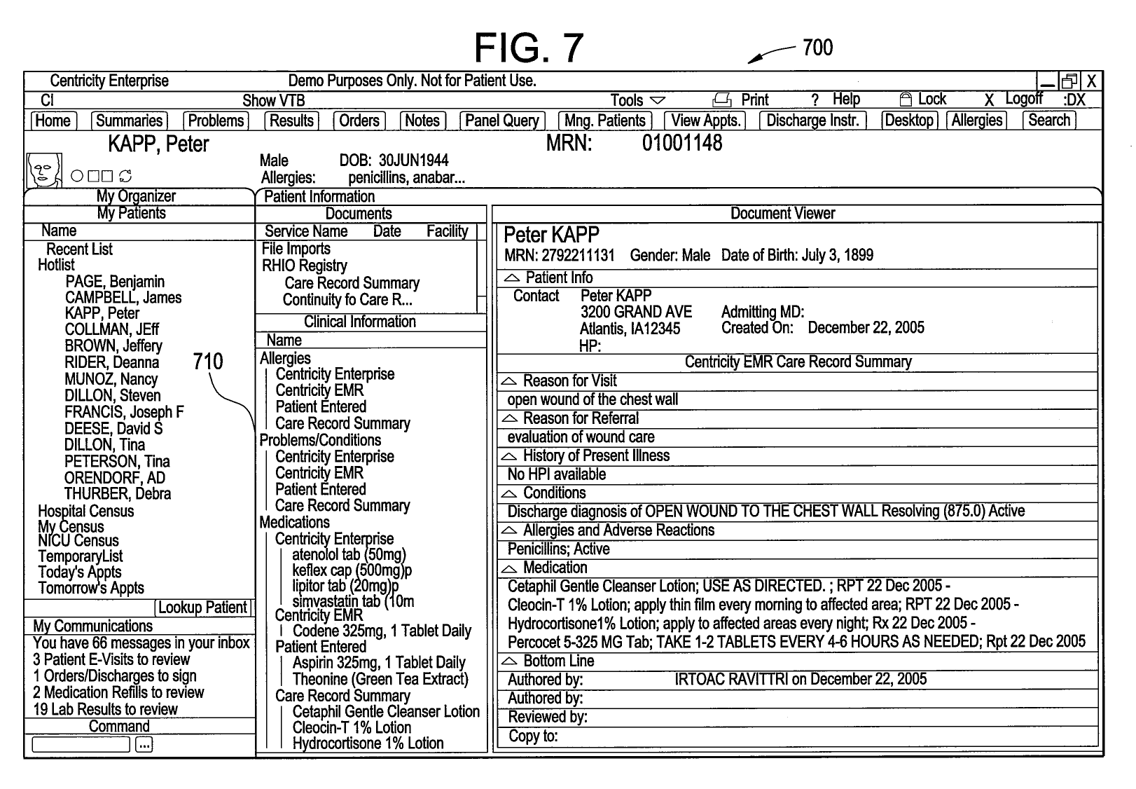

FIG. 7 illustrates an exemplary screen shot 700 of an example application of a medication management system that has been integrated into an existing information management system in accordance with an embodiment of the present invention. For example, as illustrated in FIG. 7, the system 100 may be integrated into the Centricity Enterprise system. The exemplary screen shot 700 includes medication data 710 associated with a particular patient. In the example shown, the medication data 710 includes information from four medication data sources that has been aggregated. For example, the medication data 710 includes information that has been entered by the patient, Peter Kapp, as well as information that has been provided by an EMR.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for medication management, the system including:
a user interface adapted to receive patient data;
a processor adapted to aggregate medication data from at least one medication data source based at least in part on said patient data;
a display component adapted to display said medication data.

2. The system of claim 1, wherein said medication data is associated with a plurality of medications, wherein said processor is adapted to analyze said medication data to evaluate a potential interaction between said plurality of medications.

3. The system of claim 2, wherein said medication data includes a potential interaction between said plurality of medications.

4. The system of claim 1, wherein said medication data includes at least one of a medication name, a dosage, a dosing frequency, a dosing period, dosing instructions, patient medical history data, patient allergy data, and a physical description of a medication.

5. The system of claim 1, wherein said at least one medication data source includes at least one of a hospital information system, a radiology information system, a clinical information system, a cardiovascular information system, a picture archiving and communication system, a library information system, and an electronic medical record.

6. The system of claim 1, wherein said at least one medication data source includes at least one of a doctor, a nurse, a hospital, a pharmacy, an alternative medication provider, a patient, and a user of said system.

7. The system of claim 1, wherein said at least one medication data source includes a plurality of medication data sources.

8. The system of claim 1, wherein said display component is adapted to display said medication data using at least one indicator.

9. The system of claim 1, wherein said display component is adapted to display a warning, wherein said warning includes at least one of a potential adverse consequence to a medication, a modified dosage, a modified dosing frequency, and a substitute medication.

10. The system of claim 1, wherein said processor is adapted to analyze said medication data to determine a projected outcome of administering at least one medication.

11. The system of claim 10, wherein said display component is adapted to display a predictive model based at least in part on said projected outcome.

12. A method for medication management, the method including:
selecting a patient;
aggregating medication data from at least one medication data source; and
displaying said medication data.

13. The method of claim 12, further including:
analyzing said medication data based at least in part on at least one of a rule, a local reference material, and a remote reference material.

14. The method of claim 13, wherein said medication data is associated with a plurality of medications, and wherein said medication data is analyzed to determine a potential interaction between said plurality of medications.

15. The method of claim 13, wherein said medication data is analyzed to determine a projected outcome of administering at least one medication.

16. The method of claim 12, wherein said medication data includes at least one of a medication name, a dosage, a dosing frequency, a dosing period, dosing instructions, patient medical history data, patient allergy data, and a physical description of a medication.

17. The method of claim 12, wherein said at least one medication data source includes at least one of a hospital information system, a radiology information system, a clinical information system, a cardiovascular information system, a picture archiving and communication system, a library information system, an electronic medical record, a doctor, a nurse, a hospital, a pharmacy, an alternative medication provider, and a patient.

18. The method of claim 12, wherein said at least one medication data source includes a plurality of medication data sources.

19. The method of claim 12, wherein said displayed medication data includes a warning, wherein said warning includes at least one of a potential adverse consequence to a medication, a modified dosage, a modified dosing frequency, and a substitute medication.

20. A computer-readable medium including a set of instructions for execution on a computer, the set of instructions including:
a selection routine configured to select a patient;
an aggregation routine configured to aggregate medication data from at least one medication data source; and
a display routine configured to display said medication data.
